(19) United States
(12) Patent Application Publication
(10) Pub. No.: US 2005/0104336 A1
(43) Pub. Date: May 19, 2005

(54) Gas bag module

(75) Inventors: Michael Schneider, Sulzbach (DE); Marcus Magoley, Aschaffenburg (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive Safety Systems Gmbh

(21) Appl. No.: 10/983,480

(22) Filed: Nov. 8, 2004

(30) Foreign Application Priority Data
Nov. 14, 2003 (DE) 203 17 611.1

(51) Int. Cl. B60R 21/16; B60R 21/20

(52) U.S. Cl. 280/728.2

(57) ABSTRACT

A gas bag module has a carrier part, a gas bag having an inflation opening that is surrounded by a rim and a gas bag retainer element, where the rim of the inflation opening is arranged between the gas bag retainer element and the carrier part. At least one fixing element coupled to the gas bag is arranged at the rim of the inflation opening. The fixing element, seen in a radial sectional view, is at least partially wedge-shaped or trapezoidal and is oriented with respect to the gas bag retainer element and to the carrier part such that the fixing element, when the gas bag is stressed, seeks to move the carrier part and the gas bag retainer element away from each other by a motion between the carrier part and the gas bag retainer element, based on a wedge effect.

### FIELD OF THE INVENTION

The present invention relates to a gas bag module.

### BACKGROUND OF THE INVENTION

It is known to provide a gas bag module with a gas bag retainer element that clamps a rim of an inflation opening of the gas bag between itself and a carrier part. A fixing element coupled to the gas bag and arranged at the rim of the inflation opening is used to enhance the clamping effect. Using such a fixing element, the attachment of the gas bag to a carrier part, which can be, e.g., a part of a module housing, is improved, above all in response to stress that acts upon the gas bag, e.g., when the gas bag is deployed or when a vehicle occupant impacts upon the gas bag. In both cases, it is crucial that the rim of the inflation opening remain reliably attached to the carrier part in the most gas-tight fashion possible.

### BRIEF SUMMARY OF THE INVENTION

It is an object of the present invention to optimize the fixing of a gas bag on a carrier part.

This is achieved in a gas bag module having a carrier part, a gas bag having an inflation opening that is surrounded by a rim and a gas bag retainer element, where the rim of the inflation opening is arranged between the gas bag retainer element and the carrier part. At least one fixing element coupled to the gas bag is arranged at the rim of the inflation opening. The fixing element, seen in a radial sectional view, is at least partially wedge-shaped or trapezoidal and is oriented with respect to the gas bag retainer element and to the carrier part such that the fixing element, when the gas bag is stressed, seeks to move the carrier part and the gas bag retainer element away from each other by a motion between the carrier part and the gas bag retainer element, based on a wedge effect.

Using this configuration, the fixing element, if necessary, can move a small distance radially to the outside if stress acts upon the gas bag, the clamping action exerted upon the gas bag by the retainer element and the carrier part gradually increasing. The gas bag therefore is not braked in a jerky fashion, so that the maximum forces acting upon the rim of the inflation opening are reduced in comparison to a known gas bag attachment means. In addition, as a result of at least one clamping surface, which is sloped with respect to the axis of the gas bag module and is configured on the wedge-shaped or trapezoidal section, the forces are redirected in the axial direction, so that part of the stress forces can be absorbed by an attachment device of the gas bag retainer element on the carrier part, e.g., a known screw connection. Because the clamping action increases in proportion to the force acting upon the gas bag when the fixing element moves between the gas bag retainer element and the carrier part, the clamping force acting upon the rim of the inflation opening automatically increases. Therefore, the level of biasing that is exerted by the aforementioned attaching means upon the rim of the inflation opening is no longer solely responsible for the fixing of the gas bag, in the event of stressing.

When the gas bag is subjected to stress, the fixing element may be clamped, e.g., between the carrier part and the gas bag retainer element and may be ultimately positioned so as to be immovable.

It is possible to use an annular fixing element, which completely surrounds the inflation opening. However, it is also possible, alternatively, to provide a plurality, e.g., four or five, fixing elements that are separate from each other and that are arranged at locations that are distributed over the circumference of the inflation opening. In this case, the fixing element can be configured as an annular segment, in order to achieve a uniform clamping action. The fixing element could also be configured as a slotted ring.

“Annular” here should not be understood as referring only to circular ring-shaped component parts, but rather generally also to other shapes having a recess on the inside.

To achieve a specific clamping effect, it is advantageous if the fixing element is inherently stable, i.e., in response to clamping, it does not become deformed, or does so only to a minor degree. The wedge-shaped or trapezoidal section is designed to have this shape even in an unstressed state and not to adopt it only during a clamping process.

Preferably, the fixing element is a separate component part and is not designed so as to be integral, e.g., with the gas bag or the gas bag retainer element.

The fixing element can be embedded in the rim of the inflation opening, e.g., by being sewn or woven in. The fixing element can also be joined to the gas bag by bonding, either as the exclusive attachment or in addition to being sewn or woven in.

It is also possible to carry out the coupling of the fixing element to the gas bag in that a side of the fixing element that is oriented toward the rim of the inflation opening is roughened or suitably patterned in order to increase the friction between the fixing element and the gas bag fabric. In this case, it is possible to do without a further attachment means.

In one preferred embodiment of the present invention, the gas bag retainer element and/or the carrier part in the area of the rim of the inflation opening have a contour that corresponds to the slope of the fixing element. Thus when the gas bag is stressed, both a very uniform clamping action as well as a uniformly increasing stress on the rim of the inflation opening are achieved. In this context, it is not important whether the sloped clamping surface is configured on the side oriented toward the gas bag retainer element, the side oriented toward the carrier part, or on both sides of the fixing element. What is important here is that the contour of an accommodation space, which is formed between the carrier part and the gas bag element and in which the fixing element is arranged, corresponds to the exterior contour of the fixing element. Thus, when the gas bag is stressed and there is a motion of the fixing element, resulting therefrom, that is radially directed to the outside, a uniform clamping action is generated between the clamping surface(s) and the interior side of the accommodation space, and additionally a uniformly distributed and uniformly increasing force is exerted upon the rim of the inflation opening.

The gas bag can be clamped between the gas bag retainer element and the carrier part in an area adjacent to the rim of the inflation opening, so as to assure its fixation on the carrier part, irrespective of a stressing of the gas bag.

In addition, the gas bag retainer element can be a separate gas bag retainer ring, but it can also be configured on a flange of a gas generator or on another suitable component part. The carrier part of the gas bag module is usually formed by a generator carrier, a housing, or another part of the gas bag module, which is ultimately connected to a vehicle-fixed component part, e.g., a steering wheel.

### BRIEF DESCRIPTION OF THE DRAWINGS

In the drawings:

FIG. 1 depicts a schematic half-side sectional view of a gas bag module according to the present invention;

FIG. 2 depicts an enlarged detail from FIG. 1;

FIG. 3 depicts an enlarged detail from FIG. 2 according to a first variant of a gas bag module according to the present invention;

FIGS. 3a to 3c depict fixing elements of a gas bag module according to the invention in diverse designs;

FIG. 4 depicts an enlarged detail from FIG. 2 according to a second variant of a gas bag module according to the present invention; and

FIG. 5 through FIG. 10 depict further possibilities for attaching a gas bag to a carrier part.

### DETAILED DESCRIPTION OF PREFERRED EMBODIMENTS

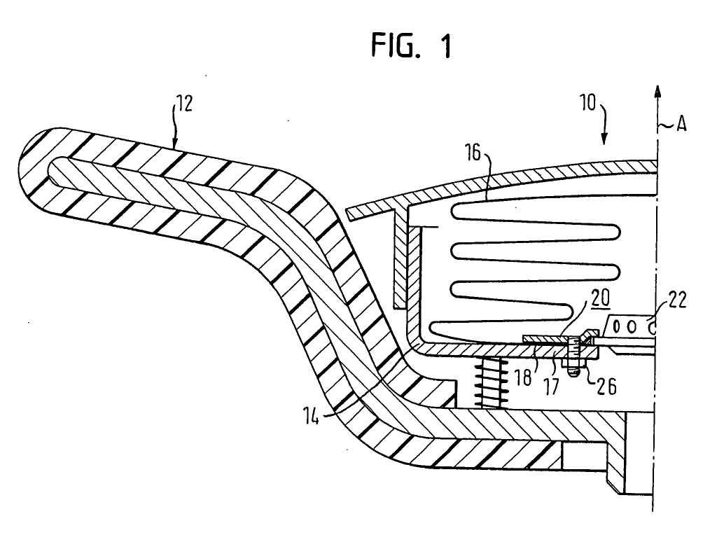

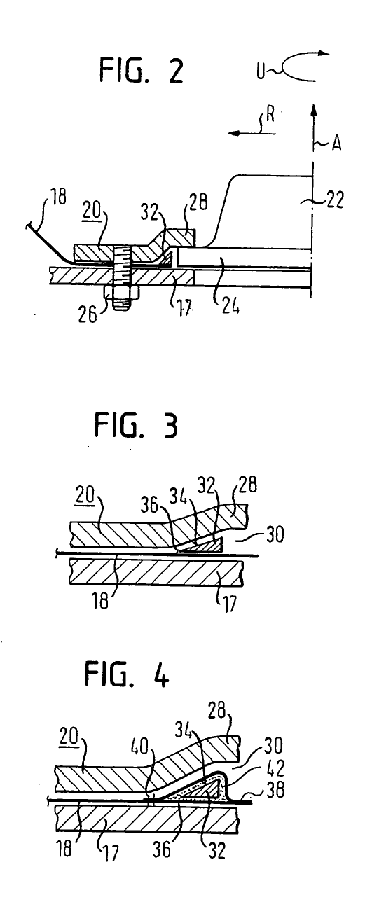

FIG. 1 shows a gas bag module 10 that is inserted in a steering wheel 12. Gas bag module 10 contains a folded gas bag 16 that is accommodated in a cup-shaped carrier part 14. A rim 18 of an inflation opening of gas bag 16 is situated between a base 17 of carrier part 14 and a separate, annular gas bag retainer element 20. Base 17 of carrier part 14 has an opening, in which a gas generator 22 is inserted, which has an annular flange 24 (see also FIG. 2), which is also arranged between gas bag retainer element 20 and base 17 of carrier part 14.

In gas bag retainer element 20, in rim 18 of the inflation opening of gas bag 16, as well as in base 17 of carrier part 14, openings are provided, through which extend attachment means 26 configured as nut-and-bolt connections, which fixedly join these parts to each other.

An rim area 28 of gas bag retainer element 20 situated in the interior in a radial direction R is bent upwards in an axial direction A of gas bag module 10, so that flange 24 of gas generator 22 can be gripped by it and clamped under it.

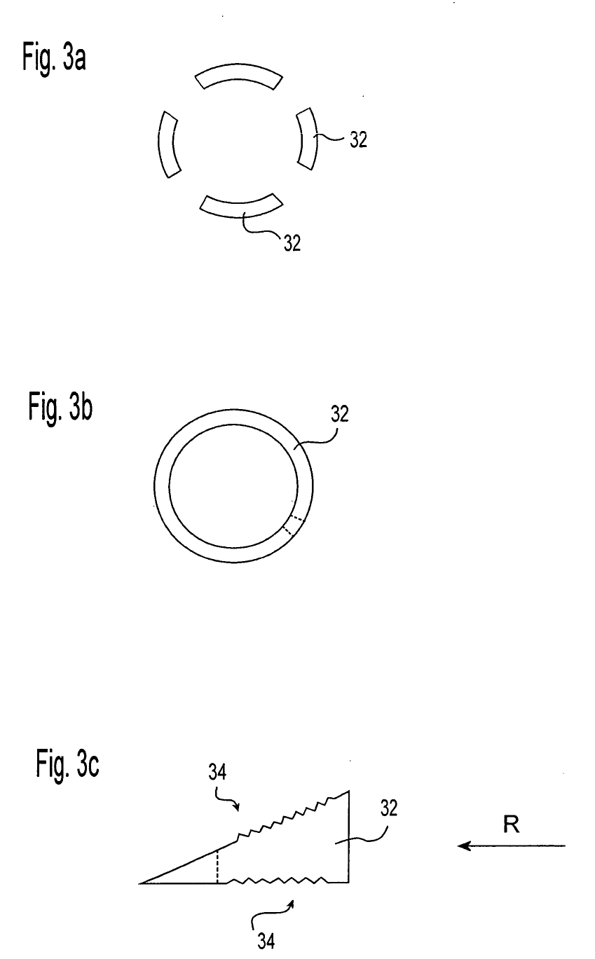

Between rim area 28 of gas bag retainer element 20 and base 17 of carrier part 14, an accommodation space 30 is formed (see FIGS. 3 and 4), in which a fixing element 32 is arranged. Fixing element 32 is coupled to rim 18 of the inflation opening of gas bag 16.

In the case depicted here, in circumferential direction U, a plurality of fixing elements 32, separate from each other, are arranged at specific locations (see FIG. 3a). However, it would also be possible to provide a single annular fixing element 32, that also could be slotted in the radial direction R (see FIG. 3b).

Each fixing element 32 is a separate, inherently stable component part, that is made of, e.g., plastic or metal.

Fixing element 32 tapers in the radial direction R in a wedge-shaped fashion and has a clamping surface 34, which is radially sloped to the outside, seen in a sectional view in the radial direction R and with respect to the axial direction A, so that tip 36 of the wedge points radially to the outside.

As can be discerned in FIGS. 2 through 4, the contour of base 17 of carrier part 14 and of gas bag retainer element 20 in the area of accommodation space 30 is fitted to the contour of fixing element 32, in particular, to the slope of clamping surface 34.

Upon a stressing of the gas bag 16, e.g., upon its deployment in case of activation of gas bag module 10, or upon impact of a vehicle occupant on the inflated gas bag 16, rim 18 of the inflation opening is radially stressed to the outside at least at a few locations over its circumference. This stressing is transmitted to fixing element 32, so that the latter also moves radially to the outside. In the process, the wedge-shaped section of fixing element 32, by clamping surface 34, contacts the interior side of accommodation space 30, in this case the interior side, oriented toward carrier part 14, of edge area 28 of gas bag retainer element 20. As a result of the contours that are coordinated with each other, fixing element 32 is displaced uniformly and continuously between gas bag retainer element 20 and carrier part 14, and it moves these parts in an axial direction A away from each other. In this context, the result is a uniform clamping force between gas bag retainer element 20, carrier part 14, rim 18 of the inflation opening, and fixing element 32, via which gas bag 16 is reliably attached to the carrier part. If the stress upon gas bag 16 is increased, then the clamping force is increased uniformly and without jerky motions, because fixing element 32 is pulled into accommodation space 30, which radially tapers to the outside. Resulting from this is a very uniform stressing for fixing rim 18 of gas bag 16 in place.

In the variant shown in FIG. 3, fixing element 32 is supported on rim 18 of the inflation opening and is coupled to rim 18 of gas bag 16 in that the side of fixing element 32 that is oriented toward rim 18 is roughened or suitably patterned in order to achieve a high degree of friction on the fabric of gas bag 16 (schematically depicted in FIG. 3c).

Alternatively, it is shown in FIG. 4 to weave fixing element 32 into rim 18 of the inflation opening of gas bag 16 (see reference numeral 38) or to sew it through stitches 40 into rim 18 of gas bag 16.

Fixing element 32 can also be joined to rim 18 of the inflation opening by an adhesive 42. An adhesive joint can be used either in addition to another attachment method, or it can function as the exclusive method of attaching fixing element 32 to gas bag 16.

In the embodiments depicted in FIGS. 3 and 4, fixing element 32 is inherently rigid and so stable that it is not deformed, or only insignificantly, when gas bag 16 is stressed. The wedge-shaped section has this shape even in the absence of a stressing of gas bag 16.

In the example depicted here, the fixing element has a sloped clamping surface 34 only on one side. It is of course equally conceivable to configure a further clamping surface on the side of fixing element 32 that is axially opposite, or, on the other hand, to configure the clamping surface only on the side of fixing element 32 that is oriented to base 17 of carrier part 14. Tip 36 of fixing element 32 can also be oriented diagonally with respect to axial direction A. In this case, the contour of accommodation space 30 must of course be adjusted accordingly.

It would also be conceivable to use a fixing element 32 having a trapezoidal cross section (see FIG. 3c) or a clamping surface 34 having a non-linear, e.g., convex or concave slope. Equally, in radial direction R as well as in peripheral direction U only one section of fixing element 32 can be configured in a wedge or trapezoidal shape.

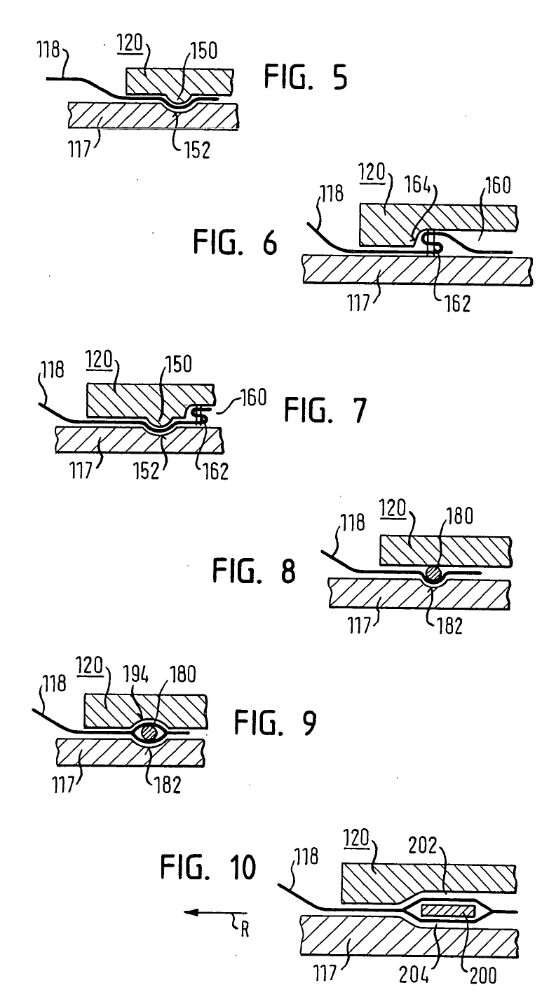

In FIGS. 5 through 10, further possibilities are shown to attach an rim 118 of an inflation opening of a gas bag between two component parts, e.g., a carrier part 117 and a gas bag retainer element 120.

In the example depicted in FIG. 5, gas bag retainer element 120 has a projection 150, whereas in carrier part 117 a groove 152 is configured corresponding to projection 150. In response to a stressing of rim 118 of the gas bag, a clamping results of rim 118 of the inflation opening of the gas bag in the area of projection 150 and of groove 152.

In the example depicted in FIG. 6, in gas bag retainer element 120 a recess 160 is provided, which constitutes an accommodation space for a thickened portion in rim 118 of the inflation opening, the thickened portion being formed by stitches 162. When stress is exerted upon rim 118, the thickened portion is pulled radially to the outside and is clamped at sloping interior wall 164 of recess 160.

The example depicted in FIG. 7 combines the fixing methods of FIGS. 5 and 6. Here, in gas bag retainer element 120, seen radially to the inside, a recess 160 for accommodating a thickened portion formed by stitches 162 follows a projection 150. Configured in carrier part 117 is a groove 152 corresponding to projection 150.

In the example depicted in FIG. 8, a fixing element 180 having a circular cross section is provided, which is separate from the other component parts depicted, and that is arranged in a groove 182 in carrier part 117. Rim 118 of the inflation opening runs between fixing element 180 and carrier part 117. In case of a tensile load upon rim 118 in radial direction R, a clamping action results between carrier part 117 and fixing element 180.

The example depicted in FIG. 9 essentially corresponds to the example from FIG. 8, with the difference that a recess 194 is also provided in gas bag retainer element 120 that corresponds in its contour to the cross section of fixing element 180.

The example depicted in FIG. 10 essentially corresponds to the example depicted in FIG. 9, with the difference that fixing element 200 has a rectangular cross section, and that recesses 202, 204 in gas bag retainer element 120 and carrier part 117, respectively, are sloped only on the side that is oriented radially to the outside, and they run towards each other, whereas their distance on the radially interior side remains larger.

Radial direction R as shown relates to all FIGS. 5 through 10.

In all the examples depicted in FIGS. 5 through 10, the clamping action upon rim 118 of the inflation opening of the gas bag, which is exerted by carrier part 117 and gas bag retainer element 120, is intensified by an appropriate shape of these two component parts, of rim 118 of the gas bag or of an additional separate fixing element 180, 200.

It would also be possible to combine one or more of the attachment methods depicted in FIGS. 5 through 10 with the gas bag attachment depicted in FIGS. 1 through 4. Likewise, the elements of the diverse embodiments can of course be freely combined with each other at the discretion of a person skilled in the art.

1. A gas bag module comprising:
a carrier part (14),
a gas bag (16) having an inflation opening that is surrounded by a rim (18),
a gas bag retainer element (20), said rim (18) of said inflation opening being arranged between said gas bag retainer element (20) and said carrier part (14), and
at least one fixing element (32) that is coupled to said gas bag (16) and that is arranged at said rim (18) of said inflation opening,
characterized in that said fixing element (32), seen in a radial sectional view, is at least partially one of wedge-shaped and trapezoidal and is oriented with respect to said gas bag retainer element (20) and to said carrier part (14) such that said fixing element (32), when said gas bag (16) is stressed, seeks to move said carrier part (14) and said gas bag retainer element (20) away from each other by a motion between said carrier part (14) and said gas bag retainer element (20), based on a wedge effect.

2. The gas bag module as recited in claim 1, wherein said fixing element (32), when said gas bag (16) is stressed, is clamped between said carrier part (14) and said gas bag retainer element (20).

3. The gas bag module as recited in claim 1, wherein said fixing element (32) has an annular shape.

4. The gas bag module as recited in claim 1, wherein said fixing element (32) is inherently stable.

5. The gas bag module as recited in claim 1, wherein said fixing element (32) is a separate component part.

6. The gas bag module as recited in claim 1, wherein said fixing element (32) is embedded in said rim (18) of said inflation opening.

7. The gas bag module as recited in claim 1, wherein said fixing element (32) is woven or sewn into said rim (18) of said inflation opening.

8. The gas bag module as recited in claim 1, wherein said fixing element (32) is joined to said rim (18) of said inflation opening by bonding.

9. The gas bag module as recited in claim 1, wherein at least one of said gas bag retainer element (20) and said carrier part (14) in the area of said rim (18) of said inflation opening have a contour that corresponds to a slope of said fixing element (32).

10. The gas bag module as recited in claim 1, wherein said gas bag (16) in an area adjacent to said rim (18) of said inflation opening is clamped between said gas bag retainer element (20) and said carrier part (14).
